(19) United States
(12) Patent Application Publication
(10) Pub. No.: US 2003/0103070 A1
(43) Pub. Date: Jun. 5, 2003

(54) Interactive display with improved visualization for product comparison, selection, and methods of operation

(75) Inventors: Philip R. Tiongson, New York, NY (US); Louis M. Weitzman, Brookline, MA (US); Jessica Wu, Cambridge, MA (US)

Correspondence Address: William E. Lewis, Ryan, Mason & Lewis, LLP, 90 Forest Avenue, Locust Valley, NY, 11560, US

(73) Assignee: International Business Machines Corporation, Armonk, NY

(21) Appl. No.: 10/281,497

(22) Filed: Oct. 28, 2002

Related U.S. Application Data
(63) Continuation of application No. 09/472,598, filed on Dec. 27, 1999, now abandoned.

(51) Int. Cl. G09G 5/00

(52) U.S. Cl. 345/700; 345/751

(57) ABSTRACT

In an information network, an interactive display allows a user to choose products or elements on one screen axis (Y) and compare their characteristics or attributes on a second screen axis (X), thereby aiding a user to select a product from all available information according to the user's individual requirements. The information network includes at least one knowledge site containing product information for access by a user through a terminal. The terminal includes a processor coupled to an interactive display and a storage disk. The processor includes a Java operating system; an application program for processing product information by categories in terms of elements and attributes, and a browser enabling a user to access and interact with the knowledge site through Java applets. The disk contains product information by category received from the knowledge site and transformed into the form of HTML parameters within HTML files.

### CROSS REFERENCE TO RELATED APPLICATIONS

This application is a continuation of the pending U.S. application identified by Ser. No. 09/472,598, filed Dec. 27, 1999, the disclosure of which is incorporated by reference herein.

### BACKGROUND OF THE INVENTION

1. Field of the Invention

This invention relates to interactive display systems and methods of operation. More particularly, the invention relates to an interactive display with improved visualization for product comparisons, selection and methods of operation.

2. Description of Prior Art:

Currently, visualization techniques on the World Wide Web have insufficient “look & feel” for many users engaging in electronic commerce. While shopping on the web, many users feel that all possible shopping alternatives are not made available to them. Moreover, the comparison of one item with another item of the same type is not available, or, if available, is visualized in a manner which makes comparison difficult.

Another pervasive problem with graphical user interfaces occurs after users interact with a system. When interacting with attributes or products, users cause changes in the state of the program. Often, the users lose their context with new information, because the information appears too quickly or instantaneously replaces the information that came before. Essentially, the users become lost in the data.

What is needed in the art is an interactive display in which a browser allows a user to dynamically compare and contrast items while shopping on the web and/or allow the comparison of data in other applications in a non-shopping environment without the user becoming lost in the comparison data.

Prior art related to interactive displays includes the following:

U.S. Pat. No. 5,970,471 issued Oct. 19, 1999 discloses a virtual product catalog and product presentation apparatus in an electronic commerce environment to assist with merchandising of products. This system includes a display, memory, and input device in which a method displays a plurality of product images on the display; provides product image review boxes on the display for side-by-side comparison of selected product images; receives the user inputs selecting a product image from the plurality of product images displayed on the display; and displays the selected product images in order of the review box or side-by-side comparison with at least one other selected product image.

U.S. Pat. No. 5,721,832 issued Feb. 24, 1998, discloses a computerized catalog system in which a customer can selectively access video and audio catalog data from a computerized catalog memory that permits a customer to peruse an entire catalog of products or services or select specific portions from specific catalogs and services. If desired, the customer can place an order which is processed electronically and for which customer profile marketing data is selectively generated.

U.S. Pat. No. 5,897,622 issued Apr. 27, 1999 discloses a merchant system for on-line shopping and merchandising. The system includes a dynamic page generator; a configurable order-processing module; and a database module capable of retrieving data from the database without regard to a schema. Merchants can create electronic orders, which are easily adaptable for different sales situations. The order-processing module includes multiple configurable stages to process a merchant's electronic order. The system is capable of generating pages dynamically using templates having embedded directives. The database module and dynamic page generator allow merchants to modify their databases and page displays without having to re-engineer the merchant's system.

U.S. Pat. No. 5,924,077 issued Jul. 13, 1999, discloses an electronic storage device for storing raw points of sale data; a data interpreter for transforming the raw data into a pre-defined standardized configuration; and a processor for deriving option values from the transformed data according to a set of mathematical/relational functions. A business rule execution engine is operatively linked to the processor and a business rule execution database. The engine allows the processor to compute corresponding mathematical/relational functions; compare the object values and corresponding reference values; and identify a past condition representative of an acceptable comparisons; a “failed” condition or a “warn” condition representative of a question of comparison. The identified condition is outputted from a processor and displayed to the user.

None of the prior art discloses or suggests an improved visualization in an interactive display in which a user can compare data or products on one axis of the display and compare attributes of the data or products on the other axis of the display while the products and attributes animate while reorganizing their screen locations in a simple, engaging, and effective visualization without the user becoming lost in the comparison data.

### SUMMARY OF THE INVENTION

An object of the invention is an interactive display and method of operation with improved visualization for data presentation, comparison and selection in an electronic commerce environment.

Another object is an interactive display and method of operation in which a browser allows a user to choose products on one axis and compare product attributes on the other axis of the display.

Another object is an interactive display and method of operation, which actively supports the user in browsing by filtering and sorting data to focus on items of interest.

Another object is an interactive display and method of operation in which screen information is presented with only the most relevant information readable at any one time.

Another object is an interactive display and method of operation in which products and attributes animate while reorganizing their screen locations.

These and other objects, features and advantages are achieved in an information network including an interactive display and method of operation which provides improved visualization to allow a user to select and organize product information by categories and attributes for on-line comparison and selection of a product in an electronic commerce environment. The information network further includes at least one knowledge site containing product and attribute information for access by a user through the interactive display. A processor is coupled to the display and a storage disk. The processor includes a Java operating system; an application program for processing product information by categories in terms of products and attributes, and a browser enabling a user to access and interact with the knowledge site through Java applets. The disk contains product information by category; each category received from the knowledge site in the form of HTML files and HTML parameters. The user accesses a knowledge site through a screen provided by the browser. The screen includes a primary category selection area; a secondary category selection area; an active table area; an Y value area for products; an Y value area for extra products; an X area for product attributes; and an X value area for extra product attributes. After accessing the knowledge site for product selection and comparison using the browser, the user selects a product category from the screen. All product categories, elements and attributes are displayed on the screen. A subcategory is selected which limits the display in the active area to the selected subcategory in a highlighted state. Additional subcategories can be added to or deleted from the current selection set. An element can be added to the active table by moving the mouse over the elements in the product overflow areas and selecting the element of interest. A similar interaction is possible for attributes. Selecting an attribute not only moves the attribute to the front of the attribute list in a highlighted state, but also sorts the active table area by that attribute. Products and their attributes can be removed from the active table area. The screen allows a user to choose products or elements on one screen axis (Y), and choose the characteristics or attributes of the products on a second screen axis (X). The desired products and attributes can then be compared. As the user interacts with the interface, the products and attributes animate while reorganizing their screen locations. A physical-based model is used for the motion of the animated elements. The animation provides a smooth movement and illustrates the continuous relationship of the elements in the table to each other. A user will better understand the new state of the display by seeing how the display context changes from one state to the next according to the user's interaction with the display.

### DESCRIPTION OF THE DRAWING

The invention will be further understood from the following detailed description of a preferred embodiment taken in conjunction with an appended drawing, in which:

FIG. 1 is a system diagram of an interactive display system incorporating the principles of the present invention.

FIG. 2 is a flow diagram for the selection of categories, products and attributes using the system of FIG. 1 and the screens of FIGS. 3-5.

FIG. 3 is a screen in the display of FIG. 1 indicating different categories of products for selection for comparison purposes.

FIG. 4 is a screen in the system of FIG. 1 after a product category has been selected in FIG. 3, and illustrating the different products in the category highlighted along the Y-axis of the screen's active table area and the attributes of the corresponding products highlighted along the X-axis.

FIG. 5 is a screen layout in the system of FIG. 1 in which the products shown in FIG. 4 have been further filtered and displays only one product subcategory with its products and attributes highlighted.

### DESCRIPTION OF PREFERRED EMBODIMENT

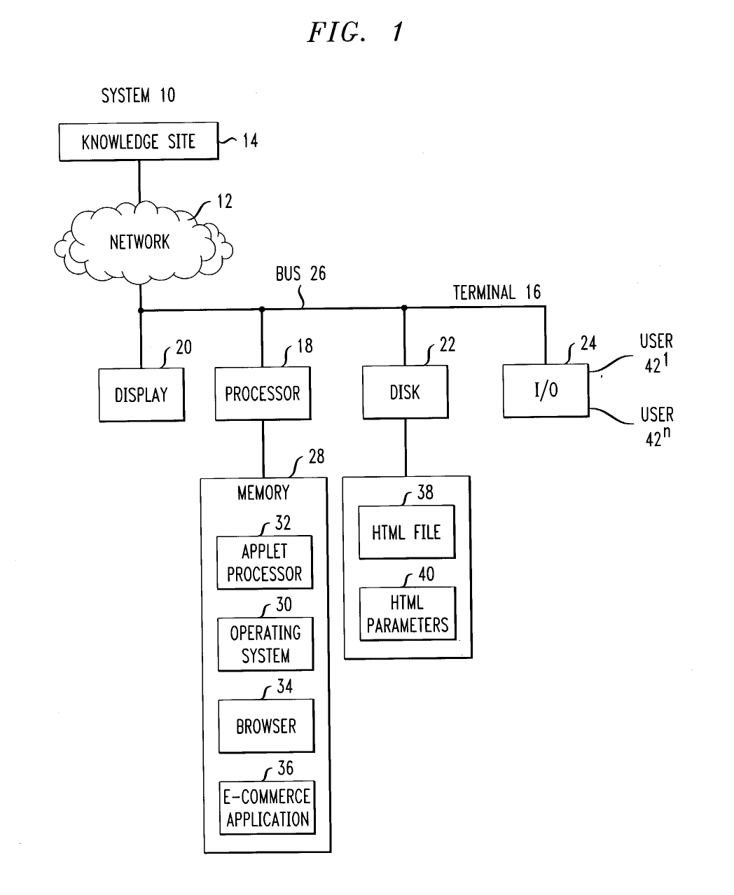

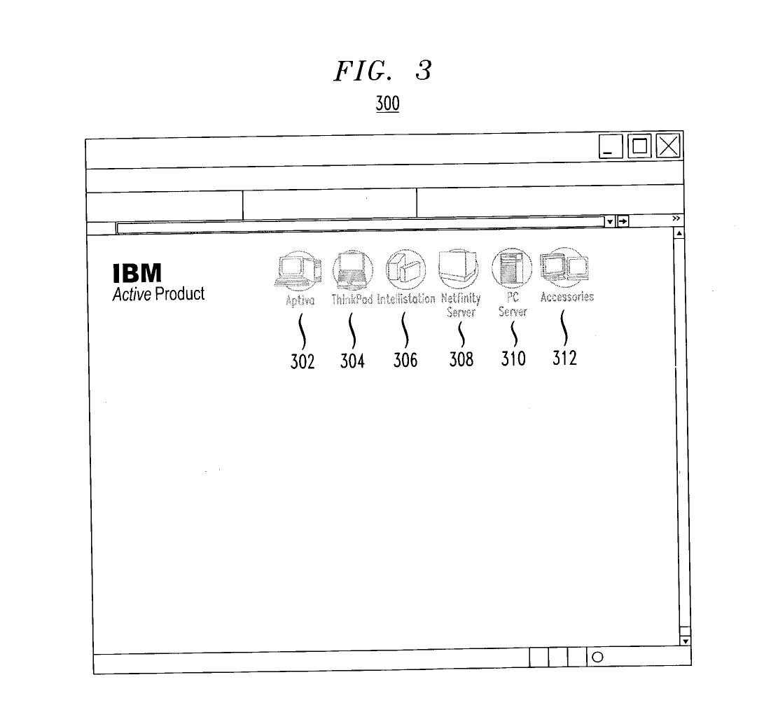

In FIG. 1 an electronic commerce system 10 includes a network 12, a knowledge site 14 in the network for providing knowledge for merchandising and the like to one or more terminals 16. One of the terminals is shown in FIG. 1 for accessing the site 14 to obtain information or purchase available products. The terminal includes a processor 18 coupled to a display 20; a disk 22 and an I/O 24 through a bus 26. The processor is coupled to a memory 28 including stored program instructions for an operating system 30, e.g., O/S2 or Windows98; a Java Virtual Machine or applet processor 32; a browser 34; and an e-commerce application 36 embedded in the browser. The e-commerce application interacts with the knowledge site in the display and selection of a product as presented in the screens to be described in connection with FIGS. 3-5. The disk 22 contains product information by category received from the knowledge site in the form of HTML files 38 and related HTML parameters 40. The I/O 24 is connected to multiple users 42¹ . . . 42ⁿ enabling the users to interact with the knowledge site in the review and selection of a product.

Product information at the knowledge site is transmitted to the user in the form of a Java applets that run in any Java enabled browser. Data is passed into the applet through the HTML applet parameters 40. Attributes include colors, position, location of image files, etc. The most relevant attribute is the product description attribute, an example of which is as follows:

| | |
|---|---|
| <PARAM NAME | = “product1” VALUE = |
| “NAME | = THINKPAD770 # |
| WEIGHT | = 7.79 lbs # |
| PRICE | = $4,618 # |
| PARTNUMBER | = 81 U # |
| PROCESSOR | = Mobile Pentium II \| with AGP # |
| MHZ | = 366 # |
| MEMORY | = 128 MB \| 320 MB SD RAM # |
| HARDDISK | = 14.1 # |
| CD/DVD | = Video Compact Disk/Digital Video Disk”> |

For each product, a PARAM tag is added with name “product N” where “N” is a sequential number for each product starting with “1”. The second argument to this tag is labeled “VALUE”. This argument is a list of alternating attribute-value pairs. The above example is for a ThinkPad 770, which includes a number of attributes (weight, price, part number, processor, MHZ, memory, hard disk and CD/DVD). These are the attributes that will be displayed in the browser on the X-axis. There can be any number of products or attributes in these PARAM tags. Typically all products will include the same attributes with non-null values.

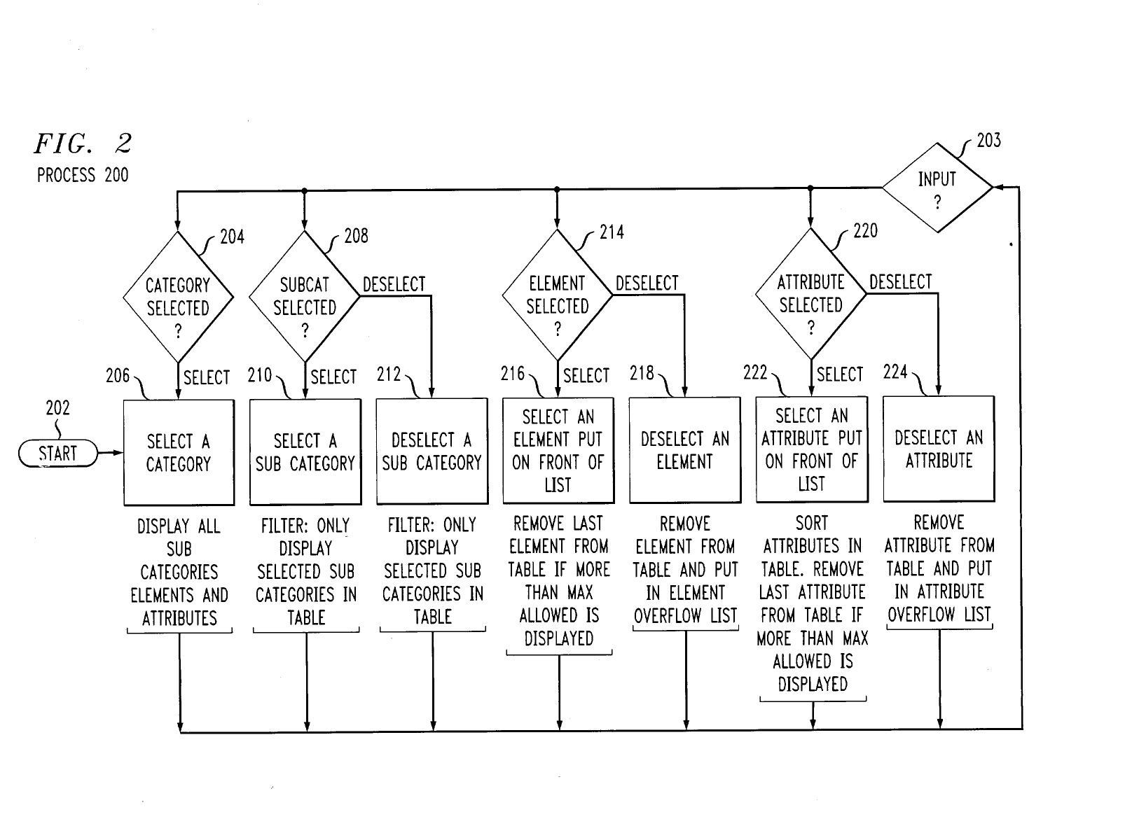

In FIG. 2, a process 200 enables a user to access the knowledge site for review and selection of a product using the screens shown in FIGS. 3-5. The process is entered in block 202 and the user provides an input 203 to initiate a category selection in block 204 for selection of a product category in block 206 among several categories shown in FIG. 3. The selection of the category displays all subcategories. In FIG. 3, screen 300 displays various product categories including, for example, a series of IBM products. In one form, these include a home computer 302, e.g., the IBM Aptiva System; a portable or laptop notebook computer 304, e.g., the IBM ThinkPad; a workstation 306, e.g., the IBM Intellistation; a workstation server 308, e.g., the IBM Netfinity server; a PC server 310 and various accessories 312.

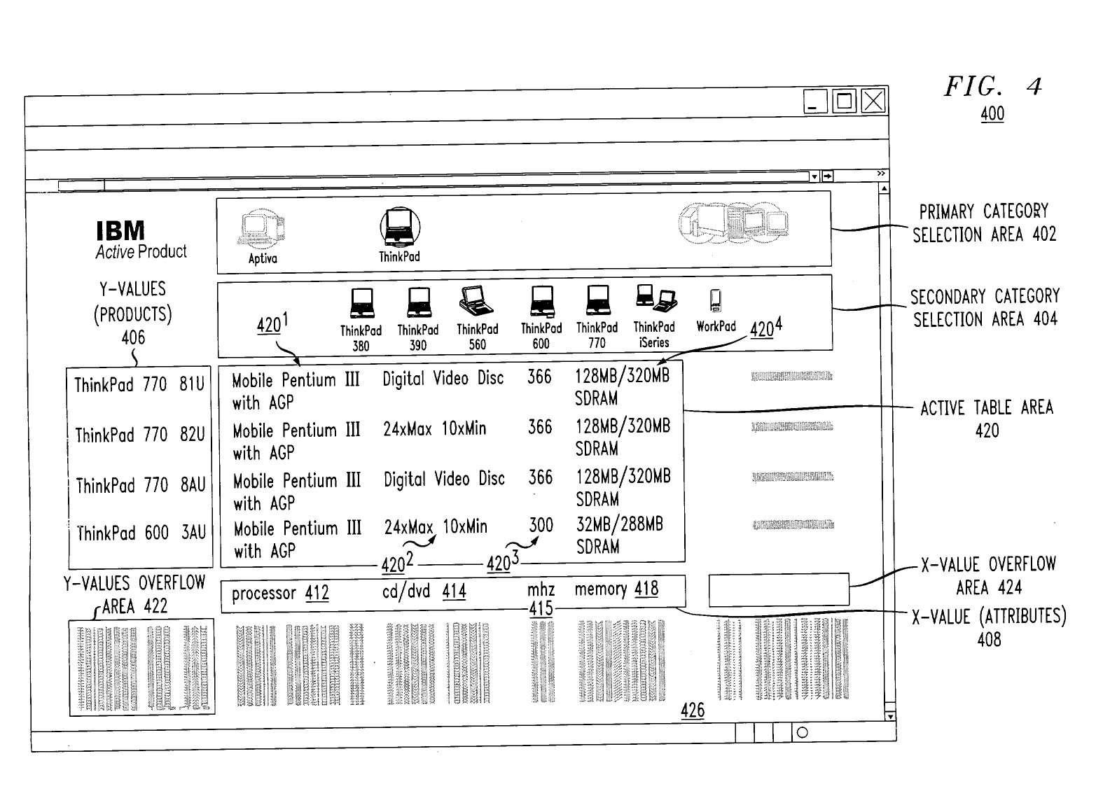

Returning to FIG. 2, the process 200 will now be further described in conjunction with FIG. 4. In FIG. 2 the user inputs the block 203 to select subcategories in block 208. The subcategories are displayed in block 210. Only the subcategories selected are displayed as shown in FIG. 4. The user also has the option to deselect a subcategory in block 212.

The user inputs the block 203 to select an element or product in block 214. Upon selection in block 216 the elements are removed from the product area if more than the maximum allowable number of products are displayed in FIG. 4. The user also has the option to deselect an element in block 218.

The user inputs the block 203 to select an attribute of a product in block 220, and in block 222 the attribute is moved to the left of the area. Only a fixed number of products and a fixed number of attributes can be displayed in the active table area at one time. In this example, that limit is set to 4 products and 4 attributes. When the list exceeds the limit for adding a new selection, the last attribute is removed from the area. The user may also deselect an attribute in block 224, afterwhich the user has all the necessary data in the screen 400 to compare and select a product without becoming lost in the data.

Now specifically turning to FIG. 4, the screen is divided into several areas beginning with a primary category selection area 402 for the selected ThinkPad category 304 in FIG. 3. The selected category appears highlighted, as compared to the other unhighlighted categories 302, 306-312 shown in FIG. 3. Highlighting, in this example, is implemented as a state with enhanced brightness. A secondary category area 404 provides a display of various ThinkPad components 405 available for comparison purposes. The subcategories 405 are shown in a highlighted state. A product area 406 lists four of the products from the subcategory area 404 and displays them along the Y-axis of the screen 400. An attribute area 408 describes four different attributes of the components shown along the Y-axis in the area 406. The attributes listed in the area 408 include processor model 412; cd/dvd characteristics 414; processor speed 416, and hard disk capacity 418. A column is established in active area 420 for each attribute. A column 420¹ details the processor characteristic for each of the components in the product area 406. A column 420² details the cd/dvd characteristics for the different component products in the area 406. A column 420³ details the processor speed of the different components in the area 406. A column 420⁴ details a hard disk capacity of the different components. A screen area 422 details additional products that may be incorporated into the area 406. A screen area 424 details extra attributes, which may be included in the area 408. A screen area 426 details attributes for the additional components shown in screen area 422. The display dynamically readjusts itself to focus and sort the selected information according to the user's interaction with the display.

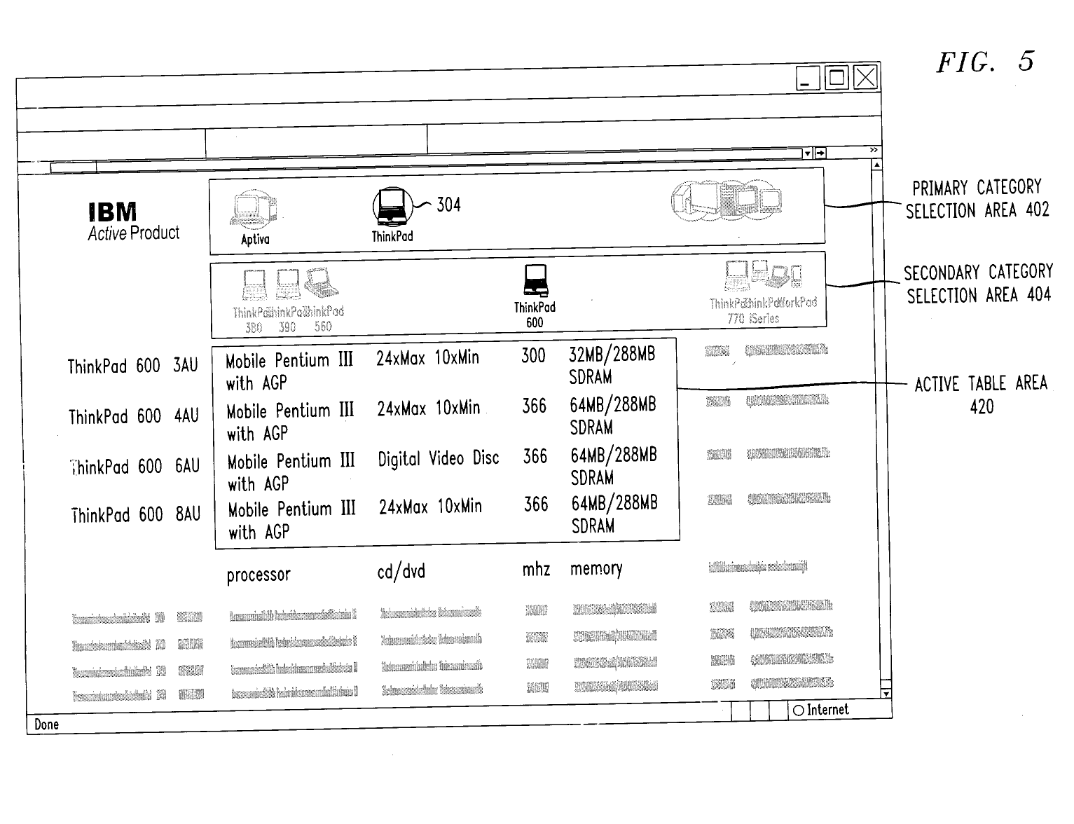

In FIG. 5, the selected ThinkPad 304 is the primary category in area 402. The category is shown in a highlighted state while the other categories are shown in an unhighlighted state. The selected subcategory ThinkPad model 600 is shown in a highlighted state in the subcategory area 404 while the other products are shown in an unhighlighted state. The attributes for the ThinkPad model 600 are shown highlighted in the active area 420 while all other information in the screen 400 is shown in an unhighlighted state.

In summary, the user selects a category by inputting block 203 in FIG. 2. Subsequently, the user can select or deselect categories, products or attributes. At any time the user can select a new top-level category in screen area 406. By selecting a category, the system will display all subcategories and the elements and attributes associated with the subcategories. The act of selecting a subcategory will restrict the display to only include the elements and attributes for that subcategory. Additional subcategories can be added or deleted with a shift-click action from the current selection set. An element can also be added to the active table area from the extra area by moving the mouse over the element, waiting for the element to highlight, and clicking on the element. This action will bring the element to the front of the list. A similar interaction is possible for attributes. Selecting an attribute not only moves the attribute to the front of the attribute list, but also sorts the active table area by that attribute. Elements and attributes can be removed from the active table area. The deselect is performed by a shift-click on the element or attribute name.

The smooth movement of objects, i.e. categories, elements, attributes, etc. in the display is achieved by modeling each object in the system as a particle with mass, acceleration, and drag. The movement of the objects on the screen mimics the movement of objects in the natural world. At any moment, each object calculates its velocity by evaluating the distance between its current position and its desired position. The object then computes its new position according to the physical model and moves to a new position. The process repeats and as a result, as an object approaches its final location, it slows down and settles into place. The intuitive feel of how lively or slowly object reacts to being moved around the screen depend on that particular object's mass and drag. Just as in the real world, an object on the screen with a large value for its mass will respond more slowly than objects with less mass, and so on. Newton's Laws of Motion are the basic models for calculating movement of the objects. Each product, attribute, and value in the table move according to these physically-based rules, creating a continuous but dynamic presentation of changing states.

Relevant information in a comparison is displayed all the time in the screen. This allows the user to comprehend the scope of the data set they are browsing. The user highlights different elements in the data set by moving the mouse over objects in the table. The highlighted item is visually distinguished from the other unselected items in the table. Clicking on a highlighted item makes the item active and brings the item into focus in the active table. The program reacts by moving the item into the table area for comparison with the other active products. At any time the user can select from the whole data set or go back to a previous selection. The movement of the objects gives users more contexts for the information they are browsing with a more usable interface and without becoming lost in the data.

In the attached Appendix I, a representative program written in pseudo code implements the process 200 of FIG. 2.

While the present invention has been shown and described in a preferred embodiment, various changes can be made without departing from the spirit and scope of the invention as defined in the appended claims.

[image]

[image]

[image]

What is claimed is:

1. Apparatus for interactively presenting information to a user, comprising:
a display screen; and
a processor coupled to the display screen and operative to: (i) obtain information relating to a set of items; (ii) generate a presentation on the display screen of at least a portion of the information relating to the set of items, the presentation comprising a comparative arrangement of two or more items of the set of items and one or more attributes associated with the two or more items; and (iii) animate movement on the display screen of at least one of one or more items and one or more attributes in response to user interaction; wherein the presentation and the animated movement provide context maintenance for the user on a single display screen with respect to the set of items.

2. The apparatus of claim 1, wherein the presentation further comprises at least one of a category selection area, a subcategory selection area, a selected item area, a selected attribute area, and a selected item/attribute comparison area.

3. The apparatus of claim 2, wherein the selected item area is arranged along one axis of the display screen and the selected attribute area is arranged along another axis of the display screen.

4. The apparatus of claim 2, wherein the presentation further comprises at least one of an overflow item area and an overflow attribute area.

5. The apparatus of claim 1, wherein the processor is further operative to execute at least one of a Java based operating system, an application program for processing information, and a browser.

6. The apparatus of claim 1, further comprising a disk, coupled to the processor, for storing information by item and attribute.

7. The apparatus of claim 1, wherein the information is obtained in an HTML format.

8. The apparatus of claim 1, wherein information relating to the set of items is obtained from one or more knowledge sites.

9. The apparatus of claim 1, wherein information relating to the set of items is obtained using one or more Java applets.

10. The apparatus of claim 1, wherein the processor is further operative to highlight selected information in the presentation, while non-selected information is not highlighted.

11. The apparatus of claim 1, wherein the processor is further operative to shift the location of selected information to the top of an area in the presentation in which the selected information is located.

12. The apparatus of claim 1, wherein the animated movement is calculated using physical laws of motion.

13. The apparatus of claim 1, wherein items are products that may be selected on-line by a user.

14. The apparatus of claim 1, wherein the generation of the presentation comprises at least one of:
reading parameters of items into an application;
organizing items along a Y-axis of the presentation;
organizing attributes of items along an X-axis of the interface;
filtering items based on a classification within categories and subcategories of an item;
enabling the user to select information in the presentation by clicking on at least one of one or more items and one or more attributes;
automatically sorting attributes as items are selected; and
enabling the user to filter items based on attribute restrictions for on-line selection of an item based on one or more user requirements.

15. A method of interactively presenting information to a user, the method comprising the steps of:
obtaining information relating to a set of items;
generating a presentation on a display screen of at least a portion of the information relating to the set of items, the presentation comprising a comparative arrangement of two or more items of the set of items and one or more attributes associated with the two or more items; and
animating movement on the display screen of at least one of one or more items and one or more attributes in response to user interaction; wherein the presentation and the animated movement provide context maintenance for the user on a single display screen with respect to the set of items.

16. The method of claim 15, wherein the presentation further comprises at least one of a category selection area, a subcategory selection area, a selected item area, a selected attribute area, and a selected item/attribute comparison area.

17. The method of claim 16, wherein the selected item area is arranged along one axis of the display screen and the selected attribute area is arranged along another axis of the display screen.

18. The method of claim 16, wherein the presentation further comprises at least one of an overflow item area and an overflow attribute area.

19. The method of claim 15, further comprising the step of storing information by item and attribute.

20. The method of claim 15, wherein the information is obtained in an HTML format.

21. The method of claim 15, wherein information relating to the set of items is obtained from one or more knowledge sites.

22. The method of claim 15, wherein information relating to the set of items is obtained using one or more Java applets.

23. The method of claim 15, further comprising the step of highlighting selected information in the presentation, while non-selected information is not highlighted.

24. The method of claim 15, further comprising the step of shifting the location of selected information to the top of an area in the presentation in which the selected information is located.

25. The method of claim 15, wherein the animated movement is calculated using physical laws of motion.

26. The method of claim 15, wherein items are products that may be selected on-line by a user.

27. The method of claim 15, wherein the generation of the presentation comprises at least one of the steps of:
reading parameters of items into an application;
organizing items along a Y-axis of the presentation;
organizing attributes of items along an X-axis of the interface;
filtering items based on a classification within categories and subcategories of an item;
enabling the user to select information in the presentation by clicking on at least one of one or more items and one or more attributes;
automatically sorting attributes as items are selected; and
enabling the user to filter items based on attribute restrictions for on-line selection of an item based on one or more user requirements.

28. An article of manufacture for interactively presenting information to a user, comprising a machine readable medium containing one or more programs which when executed implement the steps of:
obtaining information relating to a set of items;
generating a presentation on a display screen of at least a portion of the information relating to the set of items, the presentation comprising a comparative arrangement of two or more items of the set of items and one or more attributes associated with the two or more items; and
animating movement on the display screen of at least one of one or more items and one or more attributes in response to user interaction; wherein the presentation and the animated movement provide context maintenance for the user on a single display screen with respect to the set of items.

29. The article of claim 28, wherein the presentation further comprises at least one of a category selection area, a subcategory selection area, a selected item area, a selected attribute area, and a selected item/attribute comparison area.

30. The article of claim 29, wherein the presentation further comprises at least one of an overflow item area and an overflow attribute area.
